(19) United States
(12) Patent Application Publication
(10) Pub. No.: US 2006/0227113 A1
(43) Pub. Date: Oct. 12, 2006

(54) INFRARED KEYPAD ACTUATOR HAVING IMPROVED FALSE TRIGGERING RESISTANCE

(75) Inventors: David Joyce, Belmont, MA (US); Daniel M. Stearns, Canton, MA (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/907,581

(22) Filed: Apr. 6, 2005

(51) Int. Cl. G09G 5/00

(52) U.S. Cl. 345/173

(57) ABSTRACT

An actuator configured for use with an infrared (IR) touch screen device includes a flexible body having a cutout portion formed therein for viewing a display region of the touch screen device. One or more input buttons are formed in the flexible body, the one or more input buttons configured for alignment with corresponding keypad locations on the touch screen device. The one or more input buttons further include a reflective surface on a back side thereof for directly contacting the corresponding keypad areas on the touch screen device when the one or more buttons are fully depressed.

### BACKGROUND OF THE INVENTION

The present disclosure relates generally to infrared keypad actuating devices and, more particularly, to an infrared keypad actuator having improved false triggering resistance.

Touch screen systems are presently used in a variety of applications, including point-of-sale systems (e.g., restaurant and retail locations), public information displays such as information kiosks, industrial control systems, and more. Examples of basic touch screen systems that are used to record a person's touch include resistive, capacitive, surface acoustic wave, and infrared (IR) systems.

In particular, IR touch screens are widely used to correlate finger touches on a display screen by a user with soft buttons or soft keys displayed at various locations on the display screen. Typically, a number of IR emitters (e.g., transmitters) and IR detectors (e.g., receivers) are arranged around the periphery of the display screen so as to create a plurality of intersecting light paths. When emitted IR light is reflected by a nearby surface (such as a finger brought into contact with the keypad or screen), and is then received by a corresponding IR receiver, the keypad registers an input thereto. In other implementations, where a user touches the display, his or her finger blocks the IR transmission of certain perpendicularly arranged transmitter/receiver pairs. Based on the identity of the blocked pairs, the touch screen system can then determine the location of the intercept, and thus properly process a desired input of the user.

Unfortunately, for certain applications in which IR keypads or touch screens are used (such as in outdoor settings, for example) the unexpected triggering of IR receptors can occur as a result of direct sunlight or momentary light fluctuations on the IR keypad. In addition, the activation of an undesired key when programming a device through the IR keypad can also occur because of the sensitivity and close proximity of the IR components. These two problems can thus lead to undesired difficulty when programming a unit.

Accordingly, it would be desirable to be able to address the aforementioned difficulties associated with IR keypad programming such that misfiring of inputs is prevented, and the accurate activation of the IR keypad is achieved. In particular, for certain industrial applications, it is further desirable to be able to implement such features without significant changes to previously certified explosion proof enclosures, and in a manner that is relatively simple to assemble, disassemble, and align with existing equipment. It is still further desirable to implement such features in a manner that is also ultraviolet (UV) and weather stable for both outdoor and indoor environments.

### BRIEF DESCRIPTION OF THE INVENTION

The above discussed and other drawbacks and deficiencies of the prior art are overcome or alleviated by an actuator configured for use with an infrared (IR) touch screen device. In an exemplary embodiment, the actuator includes a flexible body having a cutout portion formed therein for viewing a display region of the touch screen device. One or more input buttons are formed in the flexible body, the one or more input buttons configured for alignment with corresponding keypad locations on the touch screen device. The one or more input buttons further include a reflective surface on a back side thereof for directly contacting the corresponding keypad areas on the touch screen device when the one or more buttons are fully depressed.

In another embodiment, an infrared (IR) touch screen device, includes a flexible actuator externally mounted to the surface of a keypad portion and display portion of the IR touch screen device. The flexible actuator includes a cutout portion formed therein for viewing a display region of the touch screen device, while covering the keypad portion. One or more input buttons are formed in the flexible actuator, the one or more input buttons configured for alignment with corresponding keypad locations on the touch screen device. The one or more input buttons further include a reflective surface on a back side thereof for directly contacting the corresponding keypad areas on the touch screen device when the one or more buttons are fully depressed.

### BRIEF DESCRIPTION OF THE DRAWINGS

Referring to the exemplary drawings wherein like elements are numbered alike in the several Figures:

FIGS. 1 and 2 are perspective views of existing solutions to false triggering problems with IR keypads/touch screens, utilizing visors and/or screen covers;

FIGS. 3 and 4 are perspective views of front and rear sides of a flexible actuator that is externally mountable to an IR keypad/display, in accordance with an embodiment of the invention;

FIG. 5 is center cross sectional view of the actuator shown in FIGS. 3 and 4; and

FIGS. 6 and 7 are perspective views of the actuator of FIGS. 3 through 5 used in conjunction with a device having a user actuated IR keypad/touch screen.

### DETAILED DESCRIPTION OF THE INVENTION

Disclosed herein is an infrared (IR) keypad apparatus configured for improved false triggering resistance as a result of direct sunlight or light change interference. Briefly stated, a rubber actuator is externally mounted to an IR keypad/display, such as through a tongue snapping into a small groove on the display cover, for example, and resting flush against the cover's glass window. Finger keys, when depressed, travel and contact an external window over the IR keypad, thereby disrupting the IR transmitter and receiver components within the unit so as activating the keys. In an exemplary embodiment, white colored pads disposed on the contact points (i.e., the back side of the finger keys) provide an adequate color contrast to initiate the interface.

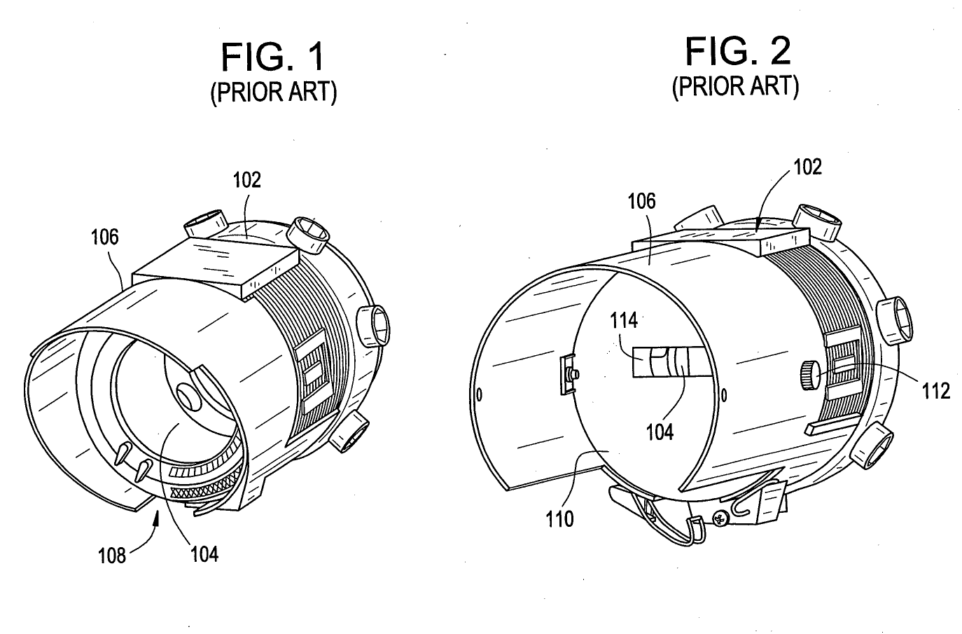

Referring initially to FIGS. 1 and 2, there is shown a pair of examples of previously existing solutions to the above described false triggering problems in outdoor IR keypad applications. In the examples depicted (as well as the embodiments described hereinafter), the IR keypad is implemented in conjunction with an industrial sensing device (e.g., a liquid flow transmitter). However, it will be understood that the principles discussed herein are equally applicable to other applications, systems and devices that employ IR keypad/touch screen sensing, programming and control.

As specifically shown in FIG. 1, a sensing device 102 is provided with an IR keypad/display screen 104, such as an IR keypad/touch screen for example, that provides a visual display of information, as well as input keys thereon for a user to input appropriate settings, commands and the like to the device 102. In outdoor environments, the presence of ambient sunlight can adversely affect the inputs to the device 102, as well as possibly generating the false triggering of unintended inputs. As such, a cylindrical, sheet metal visor 106 is shown mounted externally to the device 102, and having with a hole 108 in the bottom thereof for accessibility, as well as to provide shade over the IR keypad/screen area 104. However, depending on the location and angle of the ambient light source the, open end of the visor 106 can prove to be a disadvantage by allowing direct sunlight to be focused in on the IR components.

In response, FIG. 2 illustrates another earlier approach, in which a shield 110 is used in conjunction with the visor 106 to cover the majority of the surface area of the keypad/display screen 104. The shield 110 is mounted to the visor 106 by means of thumb screws 112 so as to allow a user to adjust its distance away from the unit. However, this arrangement proved to be cumbersome to maneuver, esthetically undesirable, and still vulnerable to light penetration through the viewing port 114 of the shield 110. Historically, customers of such devices would also use conventional umbrellas or sheets of fabric to shade the device. Unfortunately, these attempts still fail to alleviate the problem of unwanted IR key activation when programming the device 102.

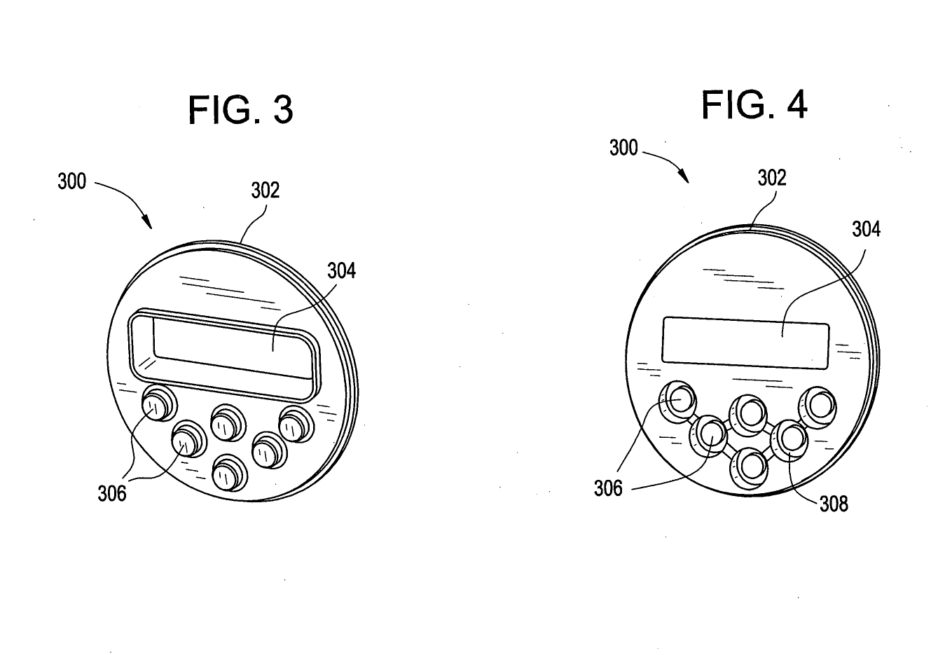

Therefore, in accordance with an embodiment of the invention, FIGS. 3 and 4 are perspective views of front and rear sides (respectively) of a flexible actuator 300 that is externally mountable to an IR keypad/display. In the exemplary embodiment depicted, the actuator 300 is formed from a body of rubber or other suitable flexible material, with a small extrusion 302 around the perimeter thereof for mounting to the cover of the IR keypad/display used in conjunction therewith. Thus, where the associated display has a round configuration, for example, (as shown in the exemplary device 102 of FIG. 102) the actuator 300 will be formed in an accommodating shape.

As further illustrated in FIGS. 3 and 4, the actuator 300 includes a cutout portion 304 for viewing the IR display, as well as a plurality of input buttons 306 that correspond to various input keypad locations on the IR display. As such, the buttons (e.g., rubber) will serve as a direct contact for the keypad locations on the IR display, in lieu of a user's fingers directly touching the screen for providing inputs to the IR device. In an exemplary embodiment, the input buttons may be solid rubber surrounded by thin rubber webbing, and are configured to travel a defined distance (e.g., about 0.1 inches) when pressed by an operator. As is particularly shown in the rear perspective view of FIG. 4, the buttons 306 may be provided with a flat, reflective surface (e.g., white) for directly contacting the corresponding IR keypad areas on the device when the buttons are fully depressed. Relief holes 308 surrounding the rear reflective side of the buttons 306 may also be provided.

Although the reflective surfaces of the backside of buttons 306 are depicted as white in the exemplary embodiment, they can alternatively be made from other colors so long as there is a sufficient color contrast with respect to the rest of the actuator material.

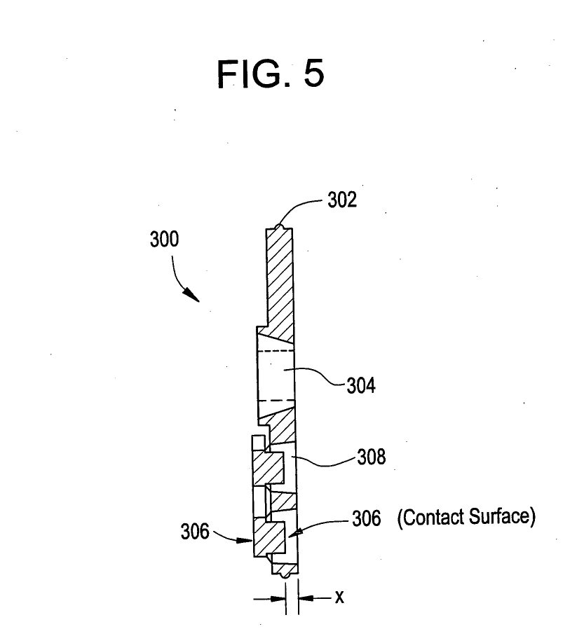

FIG. 5 is a center cross sectional view of the actuator 300 that further illustrates, among other aspects, the travel distance “x” between the rear reflective surface of an undepressed button 306 and the touch screen surface when the button 306 is depressed to make contact with the IR touch screen. In addition, the extrusion 302 around the perimeter of the actuator 300 is also illustrated, which allows for a snap fit into a mating groove on the housing of the IR keypad device.

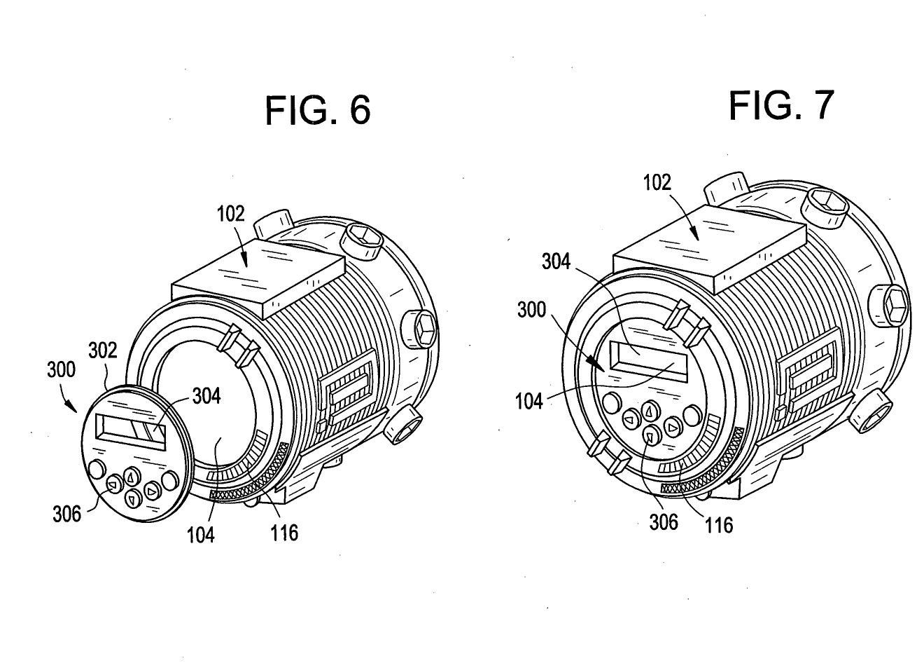

Finally, FIGS. 6 and 7 are perspective views of the actuator 300 of FIGS. 3 through 5 used in conjunction with the device 102 shown in FIGS. 1-2. FIG. 6 illustrates the actuator 300 prior to the mounting thereof on the IR keypad/screen area 104 of the sensing device 102. Again, it is to be understood that the device (and therefore the particular shape and configuration of the actuator 300) is exemplary in nature, and that other shapes, devices and implementations for the actuator 300 are contemplated. The flexible nature of the actuator 300, along with the perimeter extrusion portion 302 allows for a snap fit installation into a front cover assembly portion 116 of the device 102, as particularly shown in FIG. 7.

As will also be noted, the external labeling of the buttons 306 can correspond to the markings as actually shown on the IR keypad. For example, certain of the buttons of the actuator 300 shown in FIGS. 6 and 7 are provided with directional arrows that correspond to directional arrows provided on the keypad 104. However, other designations and button arrangements may also be used to correspond to keypad inputs including, but not necessarily limited to, alphanumeric key inputs and other specific command labels.

Thus configured, the flexible actuator provides an improved solution for combating the false triggering of an IR keypad, and in a manner that is minimally invasive with respect to the original design of the device. In other words, the actuator covers a substantial portion of the keypad/display window on the outside of the device, thus blocking the sunlight to provide a constant light variable on the IR keypad and preventing misfiring of the IR mechanism due to environmental light effects. Because the buttons on the actuator are depressed by a user (in order for the reflective surfaces thereof to contact the glass and activate the IR components), this action removes the sensitivity from activating the IR components directly. The positioning of these keys over the corresponding keypad IR components allow the user to more accurately and consistently trigger the IR keypad without unintentionally activating the wrong key.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An actuator configured for use with an infrared (IR) touch screen device, comprising:
a flexible body having a cutout portion formed therein for viewing a display region of the touch screen device;
one or more input buttons formed in said flexible body, said one or more input buttons configured for alignment with corresponding keypad locations on the touch screen device; and
said one or more input buttons further comprising a reflective surface on a back side thereof for directly contacting the corresponding keypad areas on the touch screen device when said one or more buttons are fully depressed.

2. The actuator of claim 1, wherein said flexible body comprises a rubber material.

3. The actuator of claim 2, further comprising an extrusion disposed around a perimeter of said flexible body, said extrusion configured for mounting said flexible body on the IR touch screen device.

4. The actuator of claim of claim 2, wherein said reflective surfaces are configured to be spaced apart from the touch screen device in an undepressed position.

5. The actuator of claim 4, wherein said reflective surfaces are flat.

6. The actuator of claim 4, further comprising a plurality of relief holes, said relief holes surrounding said reflective surfaces of said back sides of said one or more buttons.

7. The actuator of claim 4, wherein said one or more input buttons further comprise solid rubber buttons surrounded by a thin rubber webbing.

8. The actuator of claim 1, wherein said reflective surfaces comprise a first color and the portions of said flexible body surrounding said reflective surfaces comprise a second color, said first and second colors selected so as to provide a color contrast therebetween.

9. An infrared (IR) touch screen device, comprising:
a flexible actuator externally mounted to the surface of a keypad portion and display portion of the IR touch screen device;
said flexible actuator having a cutout portion formed therein for viewing a display region of the touch screen device, while covering said keypad portion;
one or more input buttons formed in said flexible actuator, said one or more input buttons configured for alignment with corresponding keypad locations on the touch screen device; and
said one or more input buttons further comprising a reflective surface on a back side thereof for directly contacting the corresponding keypad areas on the touch screen device when said one or more buttons are fully depressed.

10. The IR touch screen device of claim 9, wherein said flexible actuator comprises a rubber material.

11. The IR touch screen device of claim 10, further comprising an extrusion disposed around a perimeter of said flexible actuator, said extrusion configured for mounting said flexible actuator on the IR touch screen device.

12. The IR touch screen device of claim of claim 10, wherein said reflective surfaces are configured to be spaced apart from the touch screen device in an undepressed position.

13. The IR touch screen device of claim 12, wherein said reflective surfaces are flat.

14. The IR touch screen device of claim 12, further comprising a plurality of relief holes formed in said flexible actuator, said relief holes surrounding said reflective surfaces of said back sides of said one or more buttons.

15. The IR touch screen device of claim 12, wherein said one or more input buttons further comprise solid rubber buttons surrounded by a thin rubber webbing.

16. The IR touch screen device of claim 9, wherein said reflective surfaces comprise a first color and the portions of said flexible body surrounding said reflective surfaces comprise a second color, said first and second colors selected so as to provide a color contrast therebetween.
